(19) United States
(12) Patent Application Publication
(10) Pub. No.: US 2010/0207865 A1
(43) Pub. Date: Aug. 19, 2010

(54) SYSTEMS AND METHODS FOR DISPLAY DEVICE BACKLIGHT COMPENSATION

(75) Inventor: David Auld, San Jose, CA (US)

Correspondence Address: Lando & Anastasi, LLP;Z2002, One Main Street, Suite 1100, Cambridge, MA, 02142, US

(73) Assignee: ZORAN CORPORATION, Sunnyvale, CA (US)

(21) Appl. No.: 12/563,477

(22) Filed: Sep. 21, 2009

Related U.S. Application Data
(60) Provisional application No. 61/153,902, filed on Feb. 19, 2009.
(60) Provisional application No. 61/155,996, filed on Feb. 27, 2009.

(51) Int. Cl. G09G 3/36; H01J 9/42

(52) U.S. Cl. 345/102; 445/3

(57) ABSTRACT

Systems and methods of controlling illumination of a display device are disclosed. These systems and methods can detect a plurality of luminance values in a digital image of the display device that correspond to a plurality of pixel positions of the display device. A first plurality of luminance values of the plurality of luminance values can be mapped to a first pixel position of the plurality of pixel positions of the display device, and a compensation mask value for the first pixel position can be determined based upon the first plurality of luminance values. The compensation mask value can correspond to an adjustment of a luminance value of the first pixel position. The compensation mask value can be provided to a display controller of the display device to permit the display controller to adjust a luminance value of the first pixel position to correspond more closely with luminance values associated with other pixel positions of the plurality of pixel positions of the display device based upon the compensation mask value.

### CROSS REFERENCE TO RELATED APPLICATIONS

This application claims priority under 35 U.S.C. 119(e) to U.S. Provisional Application Ser. No. 61/153,902 entitled “Backlight Compensation for Wedge Light Guide,” filed Feb. 19, 2009, and to U.S. Provisional Application Ser. No. 61/155,996 entitled “Backlight Compensation for Light Guide Plate,” filed Feb. 27, 2009, both of which are incorporated herein by reference in their entirety.

### BACKGROUND OF THE INVENTION

1. Field of Invention

At least one embodiment of the present invention relates generally to display device illumination and control, and more specifically, to indirect backlight compensation for liquid crystal displays.

2. Discussion of Related Art

Electronic displays such as monitors for computers, televisions, and other electronic devices emanate light that can form images for viewing by a person. Displays of the images vary based on the nature or amount of light emanating from the electronic display. As electronic displays become larger and more complex, so too do the lighting sources used to provide the light that emanates from these electronic displays. Lighting sources for electronic displays add components, cost, and weight to everything from televisions to computer monitors and displays for other electronic devices, increasing power usage and the cost to the consumer, and decreasing efficiency. Further, the increasing size of some electronic displays for various applications can also affect lighting source component size, cost, and efficiency.

### SUMMARY OF THE INVENTION

The aspects and embodiments of the present invention are directed to systems and methods for illumination of display devices. A compensation mask can be applied to components of a display device, such as a liquid crystal display light valve of a liquid crystal display monitor. This compensation mask can compensate for non-uniformities in light propagation through the display device, and can control characteristics of the light that emits from the display device during operation or use.

At least one aspect of the present invention is directed to a method of controlling illumination of a display device. This method can detect a plurality of luminance values in a digital image of the display device that correspond to a plurality of pixel positions of the display device. A first plurality of luminance values of the plurality of luminance values can be mapped to a first pixel position of the plurality of pixel positions of the display device, and a compensation mask value for the first pixel position can be determined based upon the first plurality of luminance values. The compensation mask value can correspond to an adjustment of a luminance value of the first pixel position. The compensation mask value can be provided to a display controller of the display device to permit the display controller to adjust a luminance value of the first pixel position to correspond more closely with luminance values associated with other pixel positions of the plurality of pixel positions of the display device based upon the compensation mask value. In one embodiment, this may be done for each of the pixel positions of the display device.

Another aspect of the present invention is directed to a display manufacturing system. The display manufacturing system can include a sensor configured to detect a plurality of luminance values in a digital image of a display device, where the plurality of luminance values in the digital image correspond to a plurality of pixel positions of the display device. A system controller can be coupled to the sensor to receive the plurality of luminance values in the digital image. The system controller can be further configured to map a first plurality of luminance values of the plurality of luminance values to a first pixel position of the plurality of pixel positions of the display device and to determine a compensation mask value for the first pixel position based upon the first plurality of luminance values, where the compensation mask value corresponds to an adjustment of a luminance value of the first pixel position. The system controller can also be configured to provide the compensation mask value to a display controller of the display device to permit the display controller to adjust the luminance value of the first pixel position to correspond more closely with luminance values associated with other pixel positions of the plurality of pixel positions of the display device based upon the compensation mask value.

Another aspect of the present invention is directed to a liquid crystal display device. The liquid crystal display device can include a light source, an edge-lit light guide optically coupled to the light source, and a liquid crystal display light valve, optically coupled to the edge-lit light guide. The liquid crystal display device can also include a display device controller electrically coupled to the liquid display light valve. The display device controller can provide a plurality of pixel data signals to each of a corresponding plurality of pixel positions of the liquid crystal display light valve. The display device controller can also receive a compensation mask value corresponding to a first pixel position of the plurality of pixel positions of the liquid crystal display light valve, and can adjust a value of a first pixel data signal corresponding to the first pixel position so that a luminance value of the first pixel position corresponds more closely to luminance values of other pixel positions of the plurality of pixel positions of the display device based upon the compensation mask value.

Another aspect of the present invention is directed to a computer readable medium having stored thereon sequences of instructions. The instructions cause a processor to detect a plurality of luminance values in a digital image of the display device, the plurality of luminance values in the digital image corresponding to a plurality of pixel positions of the display device. The instructions also cause the processor to map a first plurality of luminance values of the plurality of luminance values to a first pixel position of the plurality of pixel positions of the display device, and to determine a compensation mask value for the first pixel position based upon the first plurality of luminance values, the compensation mask value corresponding to an adjustment of a luminance value of the first pixel position. The instructions further cause the processor to provide the compensation mask value to a display controller of the display device to permit the display controller to adjust a luminance value of the first pixel position to correspond more closely with luminance values associated with other pixel positions of the plurality of pixel positions of the display device.

Another aspect of the present invention is directed to a computer readable medium having stored thereon sequences of instructions. The instructions cause a processor to generate a plurality of pixel data signals for each of a plurality of pixel positions of a light valve of a liquid crystal display device, and to receive at least one compensation mask value corresponding to at least one of the plurality of pixel positions. The instructions also cause the processor to modify a value of the pixel data signal corresponding to the at least one pixel position of the display device so that a luminance value of the first pixel position corresponds more closely to luminance values of other pixel positions of a plurality of pixel positions of the display device.

In various embodiments, detecting the luminance values can include configuring a liquid crystal display light valve of the display to a pre-determined position, illuminating the display device to a maximum illumination value, and acquiring, subsequent to the acts of configuring and illuminating, the digital image of the display device. In one embodiment, determining the compensation mask value includes determining an inverse of the luminance value of the first pixel position, and using the inverse value as the compensation mask value for the first pixel.

Determining the compensation mask value may also include identifying the first pixel position of the plurality of pixel positions, identifying a second pixel position of the plurality of pixel positions, and determining the compensation mask value based on a comparison of the luminance value of the first pixel position and a luminance value of the second pixel position.

In some embodiments, the display device includes a light source, a liquid crystal display light valve, and an edge-lit light guide, and light from the light source can be directed to the liquid crystal display light valve with the edge-lit light guide. The plurality of luminance values may also be detected in situ during manufacture of the display device, subsequent to assembly of a liquid crystal display light valve, a light source, and an edge-lit light guide into the display device, and the compensation mask value may be provided to the display controller in situ during manufacture of the display device.

In one embodiment, a plurality of compensation mask values may be determined, each compensation mask value corresponding to at least one of the plurality of pixel positions. A compensation mask may be generated based at least in part on the plurality of compensation mask values and provided to the display controller. The compensation mask may also be provided to the display controller in situ during manufacture of the display device, wherein the display device includes a liquid crystal display light valve, a light source, and a light guide.

In one embodiment, at least a portion of the compensation mask may be adjusted when it is determined that a portion of the compensation mask differs from other compensation mask values by more than an expected amount from a tolerance range. The compensation mask may also be adjusted when it is determined that the compensation mask value is outside a tolerance range, and the compensation mask may be applied to the display device to reduce a luminance value of at least one pixel of the display device during operation of the display device.

At least one aspect of the present invention is directed to a method of controlling illumination of a display device. The method can include detecting a plurality of luminance values, the plurality of luminance values associated with a plurality of pixel positions of the display device. The method can also include determining a compensation mask value based on at least one of the plurality of luminance values, where the compensation mask value corresponds to at least one of the plurality of pixel positions. Further, the method can provide the compensation mask value to a display controller of the display device to adjust luminance at one of the plurality of pixel positions.

Another aspect of the present invention is directed to a display illumination system. The display illumination system can include a sensor to detect a plurality of luminance values associated with a plurality of pixel positions of a display device. A system controller can determine a compensation mask value based on at least one of the plurality of luminance values, the compensation mask value corresponding to at least one of the plurality of pixel positions. The system controller can also provide the compensation mask value to a memory unit of the display device, the memory unit associated with a display device controller.

In various embodiments, the display device controller can position a light valve of the display device in an on position, and can illuminate a light guide of a display device. A digital imaging device can generate a digital image of a display of the display device, wherein the plurality of luminance values include luminance values of a plurality of pixels of the digital image, and the system controller can map at least one of the plurality of luminance values to at least one of the plurality of pixel positions of the display device, wherein a ratio of the plurality of pixels in the digital image to pixels in the display device is at least four to one.

Other aspects, embodiments, and advantages of these exemplary aspects and embodiments will become apparent from the following detailed description, taken in conjunction with the accompanying drawings, illustrating the principles of the invention by way of example only. The foregoing information and the following detailed description include illustrative examples of various aspects and embodiments, and are intended to provide an overview or framework for understanding the nature and character of the claimed aspects and embodiments. The drawings, together with the remainder of the specification, serve to describe and explain the claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an exploded view depicting an electronic display in accordance with an embodiment;

FIG. 2 is a block diagram depicting a display manufacturing system in accordance with an embodiment;

FIG. 3 is a flow chart depicting an illumination control method of a display in accordance with an embodiment; and

FIG. 4 is a flow chart depicting an illumination control method of a display in accordance with an embodiment.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” and variations thereof herein, is meant to encompass the items listed thereafter and equivalents thereof as well as additional items.

Various aspects and embodiments are directed to electronic display illumination control, calibration, and compensation. As discussed further below, light from a light source can pass through a light guide and components of a display device, such as polarizers, brightness control films, brightness enhancement films, light valves, and glass panels. This light, passing through these components, can emanate from the display device and is viewable by a viewer. Variances in individual components can disturb the uniformity of the light distribution ultimately seen by a viewer, degrading image quality. For example, individual variances in light guides can result in a non-uniform brightness distribution of the light through electronic device components, and, ultimately, in the light emanating from each individual electronic display. These variances can be unique to a particular display device due, for example, to irregularities, inconsistencies, or deviations introduced during manufacture or assembly of the display device or its component parts.

A sensor can identify light characteristics at one or more points of electronic device components by, for example, analyzing a digital image of the illuminated display device, and a system controller can process the sensed information to generate compensation mask values that compensate for non-uniformities in luminance values between various portions of the display device. The compensation mask values can be provided to a display device controller or memory unit of the display device, for example during manufacturing of the display device. The compensation mask values, when applied to, for example, pixel positions of a liquid crystal display light valve, can compensate for non-uniformities in light distribution by adjusting luminance of at least one pixel position of the light valve, so that light emanates from the display device in a substantially uniform manner during operation.

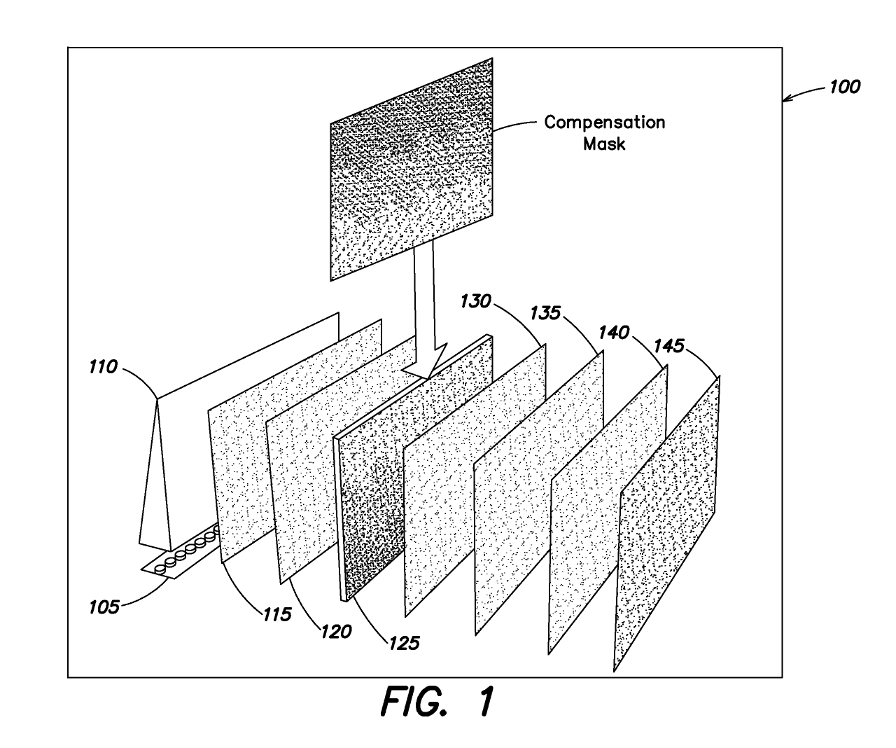

FIG. 1 is an exploded view depicting a display device 100 for the presentation of visual information in accordance with an embodiment of the present invention. Examples of display device 100 include monitors and screens for a variety of devices such as computers, televisions, personal digital assistants, mobile telephones, gaming devices, and other electronic displays. In one embodiment, display device 100 includes a liquid crystal display monitor or other electronically modulated optical device that forms part of a television, computer, or other display device.

In one embodiment, display device 100 includes a liquid crystal display monitor having a diagonal surface measurement of at least 30 inches. It is appreciated that other surface measurements, both greater than and less than 30 inches are possible. In one embodiment, display device 100 includes a liquid crystal display television with a slim design. For example, a liquid crystal display television monitor that includes display device 100 can have a depth of 0.39 inches or less. In one embodiment, light guide 110 has a depth of less than 0.06 inches and display device 100 has a diagonal surface measurement of about 52 inches. In one embodiment, light source 105 can be positioned at one edge of display device 100 in an indirect backlight configuration, such as an edge-lit configuration. This reduces both the weight of light source 105, the overall thickness and the number of lamps associated with light source 105 used to illuminate display device 100.

Display device 100 includes at least one light source 105. Light source 105 may include one or more florescent lamps, one or more light emitting diodes, such as white phosphor based light emitting diodes, red green blue (RGB) light emitting diodes, organic, quantum dot, or other electronic light sources. In one embodiment (not illustrated in FIG. 1), light source 105 can be in a direct backlight configuration to illuminate display device 100 from behind with respect to a viewer of the light emanating from display device 100.

As illustrated in FIG. 1, light source 105 includes a series of light emitting diodes in an indirect (e.g., side or edge) backlight configuration, where light is distributed from light source 105 to display device 100 via at least one light guide 110. For example, light guide 110 can be an edge-lit light guide. Light guide 110 can distribute light to an array of display device components via total internal reflection characteristics of light guide 110 and its position relative to light source 105. Light guide 110 can have a variety of shapes and forms. For example, light guide 110 can have a wedge shape as illustrated in FIG. 1. In various embodiments, light guide 110 can have tubular, rectangular, v-groove, triangular, strip or rib configurations. In one embodiment, light guide 110 is a planar light guide with microlens surface structures. Light guide 110 can be coupled to light source 105 and surfaces of light guide 110 generally maximize and linearize light output over the surface of display device 100.

In one embodiment, light guides 110 are manufactured within a given tolerance range. For example, one light guide 110 such as a wedge light guide can differ from another wedge light guide in terms of the shape, contour, or angle of its inner surface upon which light reflects during propagation through display device 100. Further, light guides 110 can be made of plastic or other flexible material, and can deform during installation into display device 100. For example, during assembly of display device 100, light guide 110 can be permanently affixed to a frame of display device 100. During this assembly, an individual light guide 110 can be deformed, which can change the reflective characteristics of light guide 110 degrading the uniformity of the light distribution emanating from light guide 110.

Degradations to the uniformity of light distribution may arise during various steps of the manufacturing or assembly process, such as the assembly of light guide 110 and light source 105 into display device 100. For example, assembly of these and other display device 100 components can change luminance characteristics of display device 100 resulting in non-uniform light distribution that varies with the amount of deformation or misalignment. In, for example, a volume manufacture environment, such as an assembly line, production, or non-testing, non-experimental environment, these changes may be particular to an individual display device 100 such that not all display devices 100 of the same design (e.g. model) are identical. Particular light distribution characteristics arise from one display device 100 with respect to another due to variances, for example within a manufacturing tolerance range, between each assembled display device 100.

Light propagated from light source 105 toward display device 100 via light guide 110 at least partially passes through a series of display components. For example, display device 100 can include a liquid crystal display (LCD) having a plurality of components. With respect to FIG. 1, in one embodiment light propagates from light source 105 via light guide 110 through display device 100, which can include at least one brightness control film 115, at least one first polarizer 120, at least one light valve 125, at least one second polarizer 130, at least one brightness enhancement control film 135, and at least one glass panel 140 where, during operation, this light is ultimately seen as image 145. In one embodiment, these components collectively form at least part of a liquid crystal display monitor. These components can block, partially block, polarize, rotate, or pass varying amounts of light. Other configurations are possible. For example, display device 100 can include more or fewer polarizers, additional filters, and more or fewer films and brightness controls.

It is appreciated that brightness control film 115 can decrease some non-uniformity intensity or luminance characteristics. However, brightness control film 115 is typically a passive element that, although being designed for a specific electronic display model or type, is not further customized to the characteristics of an individual electronic display. Thus, brightness control film 115 may not account for non-uniformity characteristics introduced into individual display devices 100 during their manufacture or assembly, for example during installation of light guide 110 into display device 100.

In one embodiment, display device 100 components illuminate light valve 125. Light valve 125 can be a liquid crystal display light valve having a plurality of individually addressable pixels with liquid crystal material aligned between transparent electrodes and between first polarizer 120 and second polarizer 130. Light valve 125 may also be a Micro Electro Mechanical System (MEMS) device. In one embodiment, light guide 110 includes an edge-lit light guide that directs light from light source 105 to light valve 125. In accordance with an aspect of the present invention, brightness (e.g., luminance or intensity) characteristics of pixels constituting light valve 125 can be modulated to compensate for variations in backlight intensity from light source 105 due, for example, to manufacturing or installation defects. For example, the intensity of light valve 125 pixels that produce uniform or substantially uniform (e.g., within a uniformity range) characteristics can be the sum of the intensity due to the image, plus a correction or compensation value. Applying this compensation value to pixels of light valve 125, for example as part of or with a drive signal, can produce an image having uniform or substantially uniform brightness characteristics and can compensate for defects to light guide 110 or other components that affect luminance and may have been introduced during manufacturing or assembly of display device 100.

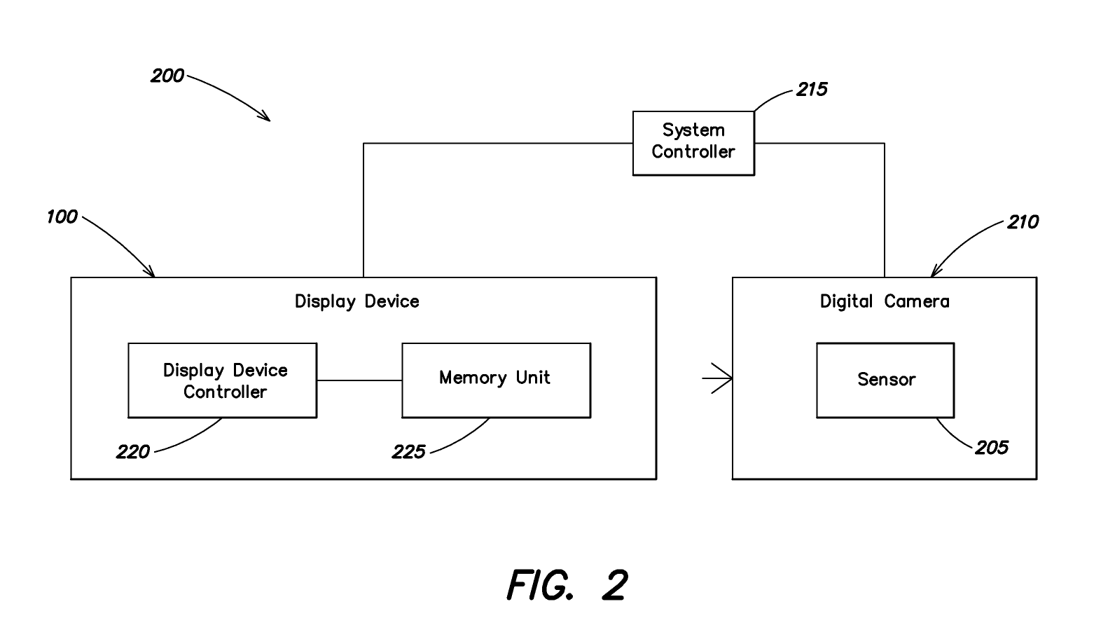

FIG. 2 is a block diagram depicting a display manufacturing system 200 in accordance with an embodiment of the present invention. In one embodiment and with respect to FIGS. 1 and 2, system 200 operates in a production or assembly line environment to control display device 100 luminance. For example, system 200 can configure display device 100 to compensate for luminance non-uniformities due to light guide 110 deformations during installation into display device 100. This may occur in situ in a production or volume assembly environment. System 200 can also control display device 100 luminance during individual testing or manual configuration in a non-production environment.

In one embodiment, system 200 includes at least one sensor 205. Sensor 205 may form part of at least one digital camera 210, part of at least one system controller 215, or may be an independent device. In one embodiment, digital camera 210 captures a digital image of display device output. For example, display device 100 can be illuminated to create image 145, and digital camera 210 takes a digital picture of image 145. In one embodiment, digital camera 210 generates the digital image of image 145 when display device 100 is illuminated at a maximum level using light source 105, with light valve 125 at a predetermined opacity level such as a full-on position. In this example, image 145 is an illuminated white screen displaying a maximum amount of luminance originating from light source 105, and digital camera 210 generates a digital image of this white screen that is image 145. Different portions of image 145 can have different and non-uniform luminosity levels, for example when illuminated as a white screen, and some of these non-uniformities may be due to installation of light source 105, light guide 110, or other components into display device 100. Alternately, display device 100 can be illuminated at less than a maximum opacity level, with light valve 125 in a less than full-on position. Here, image 145 is an illuminated white screen at less than a maximum level for that display device 100.

Digital camera 210 can capture the digital image of image 145 during production of display device 100 without removing display device 100 from the stream of production, (e.g., in situ). Sensor 205 can also detect luminance values of this digital image in situ so that it is not necessary to remove display device 100 from a volume manufacture environment for manual or individual testing. It is appreciated that in other embodiments, sensor 205 can detect display device 100 image brightness (e.g., luminance values) via a digital image in a non-volume assembly environment where display device 100 is removed from an assembly line or volume production environment and tested individually or manually.

Digital camera 210 can include any device that generates a digital image in any format, such as JPEG or RAW formats. Digital camera 210 need not be a portable, complete, separate unit digital camera suitable for consumer sale and use, and may be a digital imaging device that is part of a production line or assembly process and suitable for generating digital images of display device 100 at various stages of its assembly, manufacture, or production.

In one embodiment, the light source 105 and light guide 110 configurations provide the light that illuminates display device 100 and is imaged by digital camera 210. For example, system controller 215 can direct at least one display device controller 220 to activate light source 105 to illuminate display device 100. System controller 215 can direct light source 105 to turn on to its maximum level with light valve 125 configured in a full-on position to maximize the luminance of display device 100. Light source 105 may also turn on to less than a maximum level and light valve 125 can be configured in a partially on position. In another embodiment, at least one display device controller 220 of display device 100, which generally controls operation of display device 100, can be directed by system controller 215 to activate light source 105 of display device during its production. In this illustrative embodiment, display device controller 220 can activate display device 100 during manufacture in order to generate a display photographed by digital camera 210.

It is appreciated that image 145 is the image seen when looking at display device 100, e.g., this is the illuminated screen, or monitor seen when looking at glass panel 140 of display device 100. Digital camera 210 captures a digital image of the illuminated display device.

In one embodiment, sensor 205 detects a plurality of luminance values in the digital image generated by digital camera 210. For example, sensor 205 can detect luminance values of the digital image in situ, during manufacture of display device 100 and subsequent to installation of light valve 125, light source 105, and light guide 110 into display device 100. The luminance values in the digital image generated by digital camera 210 can correspond to pixel positions in display device 100. This correspondence may, but need not, be a 1:1 correspondence but is preferably greater than 1:1 for reasons discussed more fully below. For example, display device 100 may include a 2 megapixel display, and digital camera 210 may be a 12 megapixel digital camera. In this example, the digital image generated by digital camera 210 is a 12 megapixel image of the 2 megapixel display of display device 100. Continuing, in this example, there are 6 pixels of the digital image generated by digital camera 210 for each pixel position of display device 100 (e.g., pixels of light valve 125). In other words there is a 6:1 ratio of digital image pixels to corresponding display device 100 pixel. Thus, in this example, sensor 205 detects 6 luminance values in the digital image corresponding to each pixel of display device 100. Other ratios, e.g., 2:1, 4:1, greater than 6:1, and others are possible including non-integer ratios.

Sensor 205 may detect luminance values in the digital image that correspond to all of the pixel positions of display device 100 or a subset thereof. For example, sensor 205 may detect luminance values corresponding to half, or one third of the pixel positions of display device 100, or pixel positions at or near the edge, center, or other region of display device 100 (e.g., top dead center, lower left, etc.). In one embodiment, sensor 205 detects at least one luminance value in the digital image that corresponds to at least one pixel position of display device 100. In one embodiment, sensor 205 detects luminance values in the digital image after light source 105 and light guide 110 have been assembled into position in display device 100. In other embodiments, other values may be detected, such as chrominance, hue, saturation, or brightness indicators.

Luminance values of different portions of the digital image detected by sensor 205 may differ from each other. For example, disfigurement of light guide 110 (or other display device 100 components) during installation into display device 100 can result in a non-uniform light distribution through display device 100. In this example, luminance values at different pixels or regions of the digital image can be different from each other. In other words luminosity or intensity of one part of display device 100 can be greater than (or less than) the luminosity or intensity at another part of display device 100. In one embodiment, this nonuniformity can appear in the digital image of display device 100, and detected in the form of non-uniform luminance values by the sensor 205/system controller 215 combination.

In one embodiment, system controller 215 processes the luminance values sensed by sensor 205 and maps at least one luminance value to at least one pixel position. For example, sensor 205 detects the plurality of luminance values of the digital image, and system controller 215 determines which pixel positions of display device 100 correspond to the sensed luminance values. This may, for example, include identifying at least one corner or edge of the illuminated image of display device 100, aligning the corresponding corners or edges of the digital image, and proceeding to identify some or all remaining corresponding positions between display device 100 and the digital image using, for example, an affine transformation. As mentioned previously, the resolution of sensor 205 (e.g., 12 megapixel) can be greater than that of display device 100 (e.g., 2 megapixel) so that multiple pixels in the digital image correspond to a single pixel position of the display. This oversampling (for example by at least a 2:1 ratio) permits each pixel position on the display to be uniquely identified based on the digital image. It is appreciated that if the resolution of sensor 205 is less than that of display device 100, approximate pixel positions on the display may still be identified based on the digital image with sufficient digital processing.

In one embodiment, system controller maps luminance values of the digital image to a pixel position by averaging the luminance values corresponding to each pixel position and mapping the averaged luminance value to the corresponding pixel positions. For example, with respect to the 6:1 example discussed above, luminance values of six pixels can be averaged, for example using a two dimensional digital filter, and the averaged luminance value can be mapped to (e.g. associated with) the corresponding pixel position of display device 100. System controller 215 need not average luminance values for mapping to pixel positions. For example, when there is a 1:1 ratio between pixels of the digital image and pixels of display device 100 averaging may be unnecessary, as in this example there is one detected luminance value of the digital image that corresponds to each pixel of display device. In one embodiment, weighted averages or means may be used, or luminance values corresponding to one pixel position may be adjusted based on luminance values corresponding to other neighboring, adjacent, or remote pixel positions.

In one embodiment, system controller 215 associates at least one luminance value with at least one pixel position of display device 100. Luminance values may be in the candela per square meter unit, or may be assigned a unit-less number within a range. For example, luminance values between zero and one can be mapped (e.g., assigned) to at least one pixel position by system controller 215 based on at least one luminance value detected by sensor 205. Other ranges, e.g., zero to 255, can be used. Display device 100 may generally include 6 to 10 bit systems or greater. For example, in an 8 bit system a drive signal range for red, green, and blue subpixels may be 0 to 255, or (1 to 256). In this example, the drive signal for each of the red, green, and blue subpixel components is a number on this range, such as 232 for red, 220 for green, and 211 for blue. Continuing with this example, compensation mask values for each of these subpixel components may adjust these values of the drive signal. These adjustments may be uniform for each red, green, and blue component. For example, compensation mask values for each of these three components may reduce these values by two, which reduces their luminance during operation. Thus, the compensation mask value of −2, when applied to the corresponding pixel position as part of the drive signal during display device operation, results in values of 230 for red, 218 for green, and 209 for blue. These numbers are examples and other numbers and scale ranges may be used. It is appreciated that compensation mask values need not be the same (e.g., −2) for all subpixel components of a pixel, or for all pixels of a pixel position. For example, compensation mask values may be zero for red, −1 for green, and −1 for blue, or any other numbers on a 0 to 255 or other scale. It is appreciated that these adjustments to the subpixel component values adjust the light level by changing a voltage on a column driver of light valve 125, which results in the charge on a capacitive plate in light valve 125. The capacitive plate controls the twist of an LCD molecule, which governs the amount of light transmitted from light source 105 through display device 100.

It is appreciated that a pixel position of display device 100 can include more than one pixel of display device 100. For example, a pixel position of display device 100 can include a block of pixels, sub-pixel components, pixels at edges of display device 100, or pixels in an identified region of display device 100, e.g., corner, center, off-center, or other identifiable locations. A particular luminance value may, but need not be identified or mapped to an individual pixel. For example, a plurality of luminance values of the digital image that correspond to more than one pixel of the digital image can be mapped to a single pixel position, (e.g., a region of display device 100) that includes more than one pixel without identifying individual correspondences between luminance values of the digital image and pixels that constitute that single pixel position of display device 100. In some embodiments, a plurality of luminance values can be mapped to a pixel position that corresponds to one, more than one, less than one, less than all, or all pixels of display device 100.

In one embodiment, system controller 215 determines a compensation mask value for at least one pixel position of display device 100. The compensation mask value can compensate for non-uniform luminance characteristics of display device 100 by adjusting characteristics of at least one pixel of light valve 125 or other display device 100 component. For example, system controller 215 can map a range of luminance values from zero to one, to a plurality of pixel positions. Differences in these mapped values can indicate the extent to which luminosity of the pixel positions lacks uniformity. In one embodiment, the compensation mask value includes a correction factor that accounts for this lack of uniformity by adjusting luminance characteristics of display device 100 pixels. For example, the compensation mask value can correspond to an adjustment of the luminance of at least one pixel position. In one embodiment, a plurality of compensation mask values may collectively form, for example, a 1920×1080 pixel compensation mask when display device 100 includes a 2 megapixel display.

In one embodiment, the compensation mask value of a pixel position is an inverse of the luminance value mapped to that pixel position. For example, system controller 215 maps a luminance value to a pixel position, and this luminance value is based on the plurality of luminance values of the digital image detected by sensor 205. The luminance value mapped to a pixel position may be number between zero and one, for example 0.8. Continuing with this example, the compensation mask value for this pixel position may be the inverse value of 0.8 on the 0-1 scale, i.e., 0.2. In one embodiment, the lower limit of the compensation mask values can be set to a desired black level, e.g., zero, with the higher limit set to a desired white level, e.g., one. In one embodiment, different compensation mask values can be determined for different pixel positions of display device 100, based on the luminance values of those pixel positions. The compensation mask values can be individually determined for each pixel position of display device to which the compensation mask values are to be applied. This may be all, or a subset of pixel positions of display device 100. There are other ways in which the compensation mask values can be generated. For example, compensation mask values may be based on a mean, or a weighted or straight average of luminance values corresponding to a plurality of pixel positions.

In one embodiment, applying individual compensation mask values to each of a plurality of pixel positions of display device 100, for example as part of the drive signal adjusts the pixel characteristics of the pixels of each pixel position so that each pixel position provides light having substantially uniform luminosity. For example, the compensation mask values may reduce the luminosity of higher intensity (more luminous, or brighter) pixels more than lower intensity (less luminous, or dimmer) pixels so that each pixel position that has a compensation mask value provides light having luminous values substantially the same as the luminous value of the dimmer pixel positions. Other variations are possible. For example, compensation mask values can increase luminosity. In one embodiment, pixel positions having compensation mask values propagate light having substantially uniform luminosity when the luminance values are within 10% of each other. Other ranges are possible, such as 1%, fractions of 1%, less than 5%, and greater than 5%.

In one embodiment, the greater the compensation mask value, the more the luminance characteristics of a corresponding pixel position will be adjusted. For example, a larger compensation mask value may reduce the luminosity of its corresponding pixel position more than a smaller compensation mask value during operation of display device 100. Continuing with this example, compensation mask values at or near zero, or no compensation mask value at all, may be applied to pixel positions of light valve 125 having the lowest luminosity, and greater compensation mask values, e.g., on the 0 to 1 range example discussed above, can be applied to the pixel positions corresponding to the brighter, or more luminous pixel positions. These higher compensation mask values can, in this example, dim the luminance values of the brightest pixel positions, resulting in more uniform luminance, closer to the luminance values that correspond to the dimmer or dimmest pixel position. It is appreciated that these dimmer pixel positions are still sufficiently luminous to provide a suitable display for a viewer when in operation. In this example, compensation mask values generally reduce luminosity. In other examples, compensation mask values may increase luminosity of corresponding pixel positions, for example in conjunction with increased luminance output from light source 105.

In one embodiment, a same or substantially same compensation mask value can be applied uniformly to all pixel positions. For example, if luminance values corresponding to pixel positions of display device 100 are determined to contain levels of blue that are +3% above a threshold amount due for example to the light produced by light source 105, compensation mask values can include a −3% blue bias. In this example, further compensation mask values may be applied, or this uniform compensation mask value may be individually adjusted, to account for luminance non-uniformities between different pixel positions of display device 100.

In one embodiment, digital camera 210 can image red, green, and blue (RGB) subpixel components, and sensor 205 can detect luminance components for each subpixel component, resulting in three compensation masks, one for each red, green, and blue subpixel component for each pixel. For example, if light source 105 includes RGB light emitting diodes, the compensation mask can account for nonuniformities in the color of any of the light emitting diode subpixel components, avoiding the step of binning the light emitting diodes for brightness or uniformity prior to display device 100 assembly.

In one embodiment, system controller 215 can provide compensation mask values to at least one display controller 220 of display device 100. For example, during production of display device 100, system controller, which in one embodiment is not part of display device, can determine compensation mask values for pixel positions of display device 100, and provide this information to display device controller 100, where it may be stored in at least one memory unit 225. In this example, during end-use operation of display device 100, display device controller 220 can apply compensation mask values to light valve 125 to adjust luminance characteristics of pixels of light valve 125. The adjustments to these luminance characteristics can compensate for non-uniform luminance variances due, for example, to distortions in light guide 110 or other components that may have occurred during the production of that particular display device 100. Different compensation mask values applied to different pixel positions provide custom adjustments to each pixel position to which a compensation mask value is applied. Thus, luminance values of pixel positions to which a compensation mask value has been applied correspond more closely with each other.

In one embodiment, system controller 215 adjusts at least one compensation mask value, generating at least one adjusted compensation mask value, and provides the at least one adjusted compensation mask value to display device controller 220. For example, system controller 215 can determine that a portion of the compensation mask value differs from other compensation mask values by more than a predetermined or expected amount from a tolerance range. This may be due, for example, to dust on a lens of digital camera 210 that introduces error into the sensed luminance values of the digital image. In this example, system controller 215 can adjust compensation mask values to bring them within a tolerance range.

In one embodiment, system controller 215 identifies a plurality of pixel positions, and determines compensation mask values for these pixel positions based at least in part on a comparison of luminance values associated with the plurality of pixel positions. The compensation mask value of a first pixel position can be determined or adjusted based on the compensation mask value of an adjacent or remote second pixel position. For example, if compensation mask values of adjacent pixel positions differ sharply from each other, (e.g., more than a threshold amount) system controller 215 can determine that this discrepancy may be caused by something other than assembly introduced luminosity defects, such as interference in the rendering of the digital image. In this example, system controller 215 can adjust at least one of the compensation mask values to smooth this discrepancy by, for example, reducing the correction factor that one of the compensation mask values will have on its corresponding pixel position.

In one embodiment, system controller 215 provides at least one compensation mask value to display device 100 (e.g., display device controller 220 or memory unit 225) during production of the display device, for example in situ during manufacture of the display device, subsequent to the assembly of light valve 125, light source 105, and light guide 110 into display device 100.

Display device controller 220 in one embodiment is electrically coupled to light valve 125 and is configured to provide pixel data signals to pixel positions of light valve 125, and to receive corresponding compensation mask values, for example from system controller 215. Display device controller 220 can also adjust values of pixel data signals that correspond to pixel positions so that luminance values of those pixel positions correspond more closely to each other, e.g., within a tolerance range. In one embodiment, display device controller 220 receives compensation mask values in the form of a compensation mask during in line manufacture of display device 100. The compensation mask values permit display device controller 220 to adjust luminance values of the pixel positions during display device 100 operation.

In on embodiment, the compensation mask values form a custom compensation mask for a particular light source 105/light guide 110 assembly in a particular display device 100. For example, another light source 105/light guide 110 assembly of another display device 100 may have different luminance characteristics, resulting in a different compensation mask. Customized compensation masks can account for non-uniform light distribution on a unit by unit basis, improving luminance uniformity characteristics of individual display devices 100 that use at least some mass produced components.

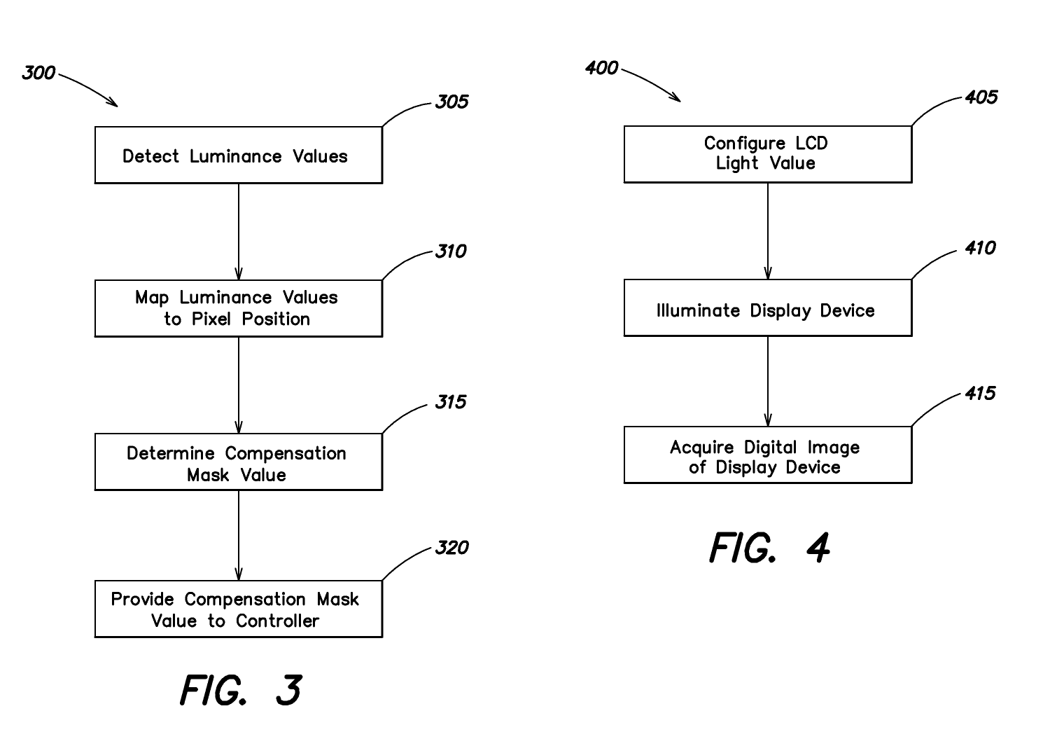

FIG. 3 is a flow chart depicting an illumination control method 300 of a display. In one embodiment, method 300 includes an act of detecting luminance values (ACT 305). For example, detecting luminance values (ACT 305) may include detecting a plurality of luminance values in a digital image of the display device, where the plurality of luminance values in the digital image correspond to at least one pixel position of the display device. In one embodiment, luminance values can be detected (ACT 305) at each of a plurality of points of an electronic device such as a liquid crystal display monitor. Further to detecting luminance values (ACT 305) method 300 may also detect chrominance, hue, saturation, or other brightness values. In one embodiment, detecting luminance values (ACT 305) includes detecting luminance values of an acquired digital image of the display output via a device such as a digital camera, when the display is at least partially illuminated.

Luminance values of a liquid crystal display monitor or other display device can be detected (ACT 305) during assembly of the display device, such as a television, or computer. In one embodiment, detecting luminance values (ACT 305) includes detecting luminance values in situ during assembly of the device or its components, such as a monitor or liquid crystal display being assembled into a television or computer. For example, luminance values can be detected (ACT 305) in line during manufacture or assembly without removing the electronic devices from an assembly line or assembly process. Luminance values can also be detected (ACT 305) that correspond to various points of, for example, a display device during in situ manufacture of the display device, after assembly of the liquid crystal display light valve, a light source, and a light guide into position within the display device.

In one embodiment, a second plurality of luminance values can be detected (ACT 305) at the same pixel positions where a first plurality of luminance values were detected (ACT 305), subsequent to detection of the first plurality of luminance values (ACT 305). The second plurality of luminance values can also be detected (ACT 305) at different pixel positions, or at a set of pixel positions that partially includes the pixel positions where the first plurality of luminance values were detected (ACT 305). In one embodiment, detecting the second plurality of luminance values (ACT 305) includes detecting the second luminance values at the same pixel positions where the first luminance values were detected, as well as additional pixel positions.

Method 300 may also include an act of mapping at least one luminance value to at least one pixel position of the display device (ACT 310). For example, the detected luminance values (ACT 305) of a digital image that correspond to pixel positions of a display device may be mapped (ACT 310) to that corresponding position. In one embodiment, mapping luminance values to pixel positions (ACT 310) includes mapping a first plurality of luminance values to a first pixel position, and mapping a second plurality of luminance values to a second pixel position.

For example, a digital image of the illuminated display device may have a higher resolution than the display device, so that multiple (e.g., four, six, or more) pixels of the digital image correspond to each pixel position of the display device. In this example, multiple luminance values may be detected (ACT 305) for each pixel position of the display device. Mapping luminance values to a pixel position (ACT 310) may include mapping multiple detected luminance values to a single pixel position that may include one or more pixels or subpixel elements. For example, a representative luminance value, (e.g., average, mean, weighted average, or other) may be determined from these multiple luminance values and mapped (ACT 310) to the corresponding pixel position of the display device. In one embodiment, when a luminance value is mapped (ACT 310) to a pixel position of the display device, that luminance value is identified as the luminance value corresponding to that pixel position under a lighting condition, such as maximum illumination, or a partial (e.g., 90%) illumination condition.

Method 300 may also include an act of determining a compensation mask value (ACT 315). In one embodiment, determining the compensation mask value (ACT 315) includes determining a compensation mask value for a pixel position of the display device based on a plurality of detected (ACT 305) luminance values. For example, the determined (ACT 315) compensation mask value can correspond to an adjustment of the luminance value corresponding to the pixel position. In this example, a luminance value can be given on a scale of zero to one, with zero being the lowest luminance value and one being the highest. Continuing with this example, if the luminance value at a pixel position is 0.8 on the zero to one scale, the compensation mask value for that pixel position can be determined (ACT 315) to be 0.2, i.e., one minus 0.8. In this example, the compensation mask value of a pixel position may be referred to as the inverse of the luminance value of that pixel position.

In one embodiment, the compensation mask value of a pixel position can be determined (ACT 315) based at least in part on compensation mask values of other pixel positions of the display device. For example, a compensation mask value of one pixel position can be adjusted so that it is within a tolerance range of other compensation mask values of other pixel positions, such as neighboring pixel positions, or pixel positions within a certain pixel position distance of the pixel position for which the compensation mask value is determined (ACT 315). These adjustments may take the form of averages, weighted averages, or discarding results determined to be outliers. Thus, a compensation mask value of a pixel position may be determined (ACT 315) taking into account the compensation mask values of other pixel positions. It is appreciated that this can smooth variances between compensation mask values due to, for example, an obstruction on an image sensor that detects (ACT 305) the plurality of luminance values that correspond to each pixel position.

In one embodiment, a plurality of compensation mask values can be determined, (ACT 315), with each compensation mask value corresponding to at least one of the plurality of pixel positions. The plurality of compensation mask values may collectively form a compensation mask. This compensation mask may include a compensation mask values corresponding to at least one pixel position. In one embodiment, the compensation mask corresponds to a subset of pixel positions of the display device that is less than all of the pixel positions of the display device. In another embodiment, the compensation mask may include compensation mask values corresponding to all pixel positions of the display device, and one compensation mask value may correspond to one or more than one pixel position. The compensation mask or compensation mask values thereof may be provided to a controller for the display device, for example during in situ manufacture of the display device that includes a liquid crystal display light valve, a light guide, and a light source, subsequent to installation of at least the light guide into the display device.

The compensation mask, or portions thereof, may be adjusted based at least in part on its compensation mask values. For example, a portion of the compensation mask can be adjusted when that portion of the compensation mask is determined to differ from another portion of the compensation mask by more than a threshold amount, or is beyond a tolerance range. In this example, the compensation mask or individual compensation mask values may be adjusted based on differences in uniformity between compensation mask values. For example, compensation mask values may be adjusted based on differences in compensation mask value uniformity outside an acceptable range. In this example, the compensation mask may be adjusted to increase luminance uniformity of a plurality of pixel positions. The compensation mask values may also be adjusted to maintain luminance values of a plurality of pixel positions within a range, or at an acceptable level.

Method 300 can also provide the compensation mask value to a display controller of the display device (ACT 320). In embodiment, providing the compensation mask to the display device controller (ACT 320) permits the display device controller to adjust at least one luminance value at a pixel position of the display device. For example, the compensation mask, when applied during operation, can adjust the luminance at a pixel position of the display device to correspond more closely with luminance values of other pixel positions of the display device. In one embodiment, a plurality of different compensation mask values can be provided (ACT 320) to the display controller, the compensation mask values each associated with a different pixel position. The different compensation mask values compensate for differences in illumination of the display device by changing the luminance value when light is propagated through the device, with some compensation mask values changing luminance more than others, resulting in increased luminance uniformity of a display device that is illuminated when compensation mask values are applied to, for example, the liquid crystal display light valve of the display device. In one embodiment, the compensation mask values, when applied, have the net effect of dimming the brighter pixel positions to more uniformly match the luminosity of the dimmer pixel positions.

In one embodiment, compensation mask values are provided to the display controller (ACT 320) in situ during manufacture of the display device. For example, compensation mask values may be provided (ACT 320) to the display controller during manufacture of a display device that includes a liquid crystal display light valve, a light source, and a light guide, (e.g., and edge-lit light guide, a wedge light guide, or a planar light guide with microlens surface structures). In this example, the compensation mask values can be provided (ACT 320) to the display controller during assembly of the display device, subsequent to installation of at least the light guide into the display device. The compensation mask values can be provided (ACT 320) to the display device controller in the form of a compensation mask, and the compensation mask including associated compensation mask values can be stored in a memory unit of the display device that is associated with the controller. In one embodiment, the compensation mask can be applied to the light valve during use of a liquid crystal display monitor by a customer or consumer.

FIG. 4 is a flow chart depicting an illumination control method 400 of detecting luminance values in a digital image of a display device. In one embodiment, method 400 includes detecting the luminance values as described above with respect to ACT 305. The detecting acts of method 400 may include an act of configuring a liquid crystal display light valve of the display to a predetermined position (ACT 405). For example, the light valve may be configured (ACT 405) to a fully on position that maximizes the amount of light that propagates through the light valve of the display device. The light valve can be configured (ACT 405) to a variety of positions other than a fully on position that prevent some light from passing through the light valve. For example, the light valve can be configured (ACT 405) to be at least 95% open, 50% open, 33% open, or other values between 0-100% open. With reference to FIGS. 3 and 4, detected luminance values (ACT 305) when the light valve is configured in a fully on position (ACT 405) can be greater than detected luminance values (ACT 305) when the light valve is configured to be in less than a fully on position (ACT 405) because this latter configuration can prevent some light from propagating through the liquid crystal display light valve.

In one embodiment, method 400 includes an act of at least partially illuminating the display device (ACT 410). For example, illuminating the display device (ACT 410) may include activating the light source coupled to the light guide of the display device so that light propagates from the light source, via the light guide, through the configured (ACT 405) light valve of the display device. In one embodiment, the display device can be illuminated (ACT 410) to a maximum value, for example by turning on the light source to its maximum capacity. The display device can also be illuminated (ACT 410) to less than its maximum value by, for example, dimming or reducing light that emanates from the light source. This can reduce any resulting luminance values detected (ACT 305) in the digital image of the display device.

In one embodiment, the liquid crystal display light valve can be configured (ACT 405) and the display device illuminated (ACT 410) in situ during manufacture of the display device. These acts may also occur during the assembly process but subsequent to installation of at least the light guide into the display device.

In one embodiment, acts of method 300 and 400 occur in situ during manufacture of the display device. For example, these acts may be performed in a volume assembly line or mass production environment and implemented while components of the display device remain in the assembly line environment. In this illustrative example, these acts may be performed during in line assembly of the display device as part of the assembly process, without removing the electronic device or any of its components from the assembly line or manufacturing process. The display device, for example, can be an optical display device that includes a liquid crystal display light valve, a liquid crystal display monitor, a light source, a light guide, and one or more brightness control films or polarizers. In one in situ embodiment, luminance values are detected (ACT 305) subsequent to assembly of a light source and light guide into the display device during manufacture of the display device or components thereof. For example, the light source, light guide, and light valve of a monitor can be assembled into a frame for a television or computer monitor. The detected (ACT 305) luminance values can include luminance values of light from a light source propagated via a light guide through the display device, where the light source and light guide have been assembled in an indirect backlight (e.g., edge) configuration into fixed positions within the display device. It is appreciated that in this example, non-uniformity luminance characteristics introduced into the display device during assembly of the light source and light guide can be detected (ACT 305) and compensation for by the compensation mask values.

In one embodiment, a method of manufacturing an electronic device includes all acts of methods 300 and 400. In this illustrative embodiment, a light source can be coupled with a light guide, with the plurality of luminance values of a digital image and corresponding to at least on pixel position detected (ACT 305). The detected luminance values can be mapped (ACT 310) to at least one pixel position to associate a luminance value with that pixel position. The compensation mask value can be determined (ACT 315) based on that the luminance value mapped to the pixel position and provided (ACT 320) to a display controller of the display device.

Note that in FIGS. 1 to 4, the enumerated items are shown as individual elements. In actual implementations of the systems and methods described herein, however, they may be inseparable components of other electronic devices such as a digital computer. Thus, actions described above may be implemented at least in part in software that may be embodied in an article of manufacture that includes a program storage medium. The program storage medium includes data signals embodied in one or more of a carrier wave, a computer disk (magnetic, or optical (e.g., CD or DVD, or both)), non-volatile memory, tape, a system memory, and a computer hard drive.

From the foregoing, it will be appreciated that the luminance control provided by the systems and methods described herein afford a simple and effective way to customize individual electronic displays with uniform luminance characteristics in a volume, manufacturing, or assembly environment. The systems and methods according to various embodiments are able to account for luminance uniformity disturbances introduced into electronic display devices during their assembly, due for example to deformation and material stresses of electronic display device components, such as a light guide. This increases efficiency and performance, and reduces the cost, weight, and physical size (e.g., depth) of the electronic display devices.

Any references to front and back, left and right, top and bottom, or upper and lower and the like are intended for convenience of description, not to limit the present systems and methods or their components to any one positional or spatial orientation.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence have any limiting effect on the scope of any claim elements.

One skilled in the art will realize the systems and methods described herein may be embodied in other specific forms without departing from the spirit or essential characteristics thereof. For example, hue, saturation, chrominance, brightness, or characteristics other than luminance can be detected, evaluated to generate a compensation mask, and adjusted. The foregoing embodiments are therefore to be considered in all respects illustrative rather than limiting of the described systems and methods. Scope of the systems and methods described herein is thus indicated by the appended claims, rather than the foregoing description, and all changes that come within the meaning and range of equivalency of the claims are therefore intended to be embraced therein.

What is claimed is:

1. A method of controlling illumination of a display device, comprising acts of:
detecting a plurality of luminance values in a digital image of the display device, the plurality of luminance values in the digital image corresponding to a plurality of pixel positions of the display device;
mapping a first luminance value based on the plurality of luminance values to a first pixel position of the plurality of pixel positions of the display device;
determining a compensation mask value for the first pixel position based upon the first luminance value, the compensation mask value corresponding to an adjustment of a luminance value of the first pixel position; and
providing the compensation mask value to a display controller of the display device to permit the display controller to adjust a luminance value of the first pixel position to correspond more closely with luminance values associated with other pixel positions of the plurality of pixel positions of the display device based upon the compensation mask value.

2. The method of claim 1, wherein the act of detecting includes:
configuring a liquid crystal display light valve of the display to a pre-determined opacity level; and
at least partially illuminating the display device.

3. The method of claim 1, wherein the act of detecting includes:
configuring a liquid crystal display light valve of the display to a full-on opacity level;
illuminating the display device to a maximum illumination value; and
acquiring, subsequent to the acts of configuring and illuminating, the digital image of the display device.

4. The method of claim 3, wherein the act of mapping includes:
mapping a second luminance value based on the plurality of luminance values to a second pixel position of the plurality of pixel positions of the display device.

5. The method of claim 1, wherein the act of determining includes:
determining an inverse value of the luminance value of the first pixel position; and
using the inverse value as the compensation mask value for the first pixel.

6. The method of claim 1, wherein the act of determining includes:
identifying the first pixel position of the plurality of pixel positions;
identifying a second pixel position of the plurality of pixel positions, and
determining the compensation mask value based on a comparison of the luminance value of the first pixel position and a luminance value of the second pixel position.

7. The method of claim 6, wherein the act of determining the compensation mask value includes:
determining the compensation mask value based on a weighted average of the luminance value of the first pixel position and the luminance value of the second pixel position.

8. The method of claim 1, wherein the display device includes a light source, a liquid crystal display light valve, and an edge-lit light guide, further comprising:
directing light from the light source to the liquid crystal display light valve with the edge-lit light guide.

9. The method of claim 1, wherein the act of detecting includes:
detecting the plurality of luminance values in situ during manufacture of the display device, subsequent to assembly of a liquid crystal display light valve, a light source, and an edge-lit light guide into the display device.

10. The method of claim 9, wherein the act of providing includes:
providing the compensation mask value to the display controller in situ during manufacture of the display device.

11. The method of claim 1, further comprising:
determining a plurality of compensation mask values, each compensation mask value corresponding to at least one of the plurality of pixel positions;
generating a compensation mask based at least in part on the plurality of compensation mask values; and
providing the compensation mask to the display controller.

12. The method of claim 11, wherein the act of providing the compensation mask to the display controller includes:
providing the compensation mask to the display controller in situ during manufacture of the display device, wherein the display device includes a liquid crystal display light valve, a light source, and a light guide.

13. The method of claim 11, further comprising:
determining whether a portion of the compensation mask differs from other compensation mask values by more than an expected amount from a tolerance range; and
adjusting the portion of the compensation mask.

14. The method of claim 1, further comprising:
determining the compensation mask value is outside a tolerance range; and
adjusting the compensation mask value.

15. The method of claim 1, further comprising:
applying the compensation mask to the display device to reduce a luminance value of at least one pixel of the display device during operation of the display device.

16. The method of claim 1, wherein the first plurality of luminance values includes at least four luminance values; and wherein the act of mapping includes mapping the at least four luminance values to the first pixel position.

17. A display manufacturing system, comprising:
a sensor configured to detect a plurality of luminance values in a digital image of a display device, the plurality of luminance values in the digital image corresponding to a plurality of pixel positions of the display device;
a system controller coupled to the sensor, to receive the plurality of luminance values in the digital image, the system controller be configured
to map a first luminance value based on the plurality of luminance values to a first pixel position of the plurality of pixel positions of the display device;
to determine a compensation mask value for the first pixel position based upon the first luminance value, the compensation mask value corresponding to an adjustment of a luminance value of the first pixel position; and
to provide the compensation mask value to a display controller of the display device to permit the display controller to adjust the luminance value of the first pixel position to correspond more closely with luminance values associated with other pixel positions of the plurality of pixel positions of the display device based upon the compensation mask value.

18. The system of claim 17, wherein the sensor is configured to detect the plurality of luminance values in situ during manufacture of the display device, subsequent to assembly of a light valve, a light source, and a light guide into the display device.

19. The system of claim 18, wherein the system controller is configured to provide the compensation mask value to the display controller during manufacture of the display device.

20. The system of claim 17, wherein the system controller is configured to adjust the compensation mask value to generate an adjusted compensation mask value, and to provide the adjusted compensation mask value as part of a compensation mask to the display device controller.

21. The system of claim 17, wherein the compensation mask value corresponds to an inverse of the luminance value of the first pixel position.

22. The system of claim 17, wherein the system controller is configured to:
identify the first pixel position of the plurality of pixel positions;
identify the second pixel position of the plurality of pixel positions; and
determine the compensation mask value based at least in part on a comparison of the luminance value of the first pixel position and a luminance value of the second pixel position.

23. A liquid crystal display device, comprising
a light source;
an edge-lit light guide optically coupled to the light source;
a liquid crystal display light valve, optically coupled to the edge-lit light guide; and
a display device controller, electrically coupled to the liquid display light valve, the display device controller being configured to provide a plurality of pixel data signals to each of a corresponding plurality of pixel positions of the liquid crystal display light valve, to receive a compensation mask value corresponding to a first pixel position of the plurality of pixel positions of the liquid crystal display light valve, and to adjust a value of a first pixel data signal corresponding to the first pixel position so that a luminance value of the first pixel position corresponds more closely to luminance values of other pixel positions of the plurality of pixel positions of the display device based upon the compensation mask value.

24. The device of claim 23, wherein the display device controller is configured to:
position a light valve of the display device in a full-on opacity level position; and
illuminate the display device to a maximum illumination value.

25. The device of claim 23, wherein the display device controller is configured receive the compensation mask value as part of a compensation mask during in line manufacture of the display device.

26. The device of claim 23, wherein the display device includes a liquid crystal display monitor, wherein the edge-lit light guide and light source are configured to illuminate the liquid crystal display monitor, and wherein a diagonal surface of the liquid crystal display monitor is at least 30 inches.

27. A computer readable medium having stored thereon sequences of instructions including instructions that will cause a processor to:
detect a plurality of luminance values in a digital image of the display device, the plurality of luminance values in the digital image corresponding to a plurality of pixel positions of the display device;
map a first luminance value based on the plurality of luminance values to a first pixel position of the plurality of pixel positions of the display device;
determine a compensation mask value for the first pixel position based upon the first luminance value, the compensation mask value corresponding to an adjustment of a luminance value of the first pixel position; and
provide the compensation mask value to a display controller of the display device to permit the display controller to adjust a luminance value of the first pixel position to correspond more closely with luminance values associated with other pixel positions of the plurality of pixel positions of the display device.

28. The computer readable medium of claim 27, further comprising instructions that will cause the processor to:
determine a plurality of compensation mask values, each compensation mask value corresponding to at least one of the plurality of pixel positions;
generate a compensation mask based at least in part on the plurality of compensation mask values; and
provide the compensation mask to the display controller.

29. The computer readable medium of claim 27, further comprising instructions that will cause the processor to:
configure a liquid crystal display light valve of the display to a full-on position;
illuminate the display device to a maximum illumination value; and
acquire, subsequent to the acts of configuring and illuminating, the digital image of the display device.

30. A computer readable medium having stored thereon sequences of instructions including instructions that will cause a processor to:
generate a plurality of pixel data signals for each of a plurality of pixel positions of a light valve of a liquid crystal display device;
to receive at least one compensation mask value corresponding to at least one of the plurality of pixel positions; and
to modify a value of the pixel data signal corresponding to the at least one pixel position of the display device so that a luminance value of the first pixel position corresponds more closely to luminance values of other pixel positions of a plurality of pixel positions of the display device.

31. The computer readable medium of claim 30, further comprising instructions that will cause the processor to:
receive the compensation mask value as part of a compensation mask during in line manufacture of the display device, subsequent to assembly of the light source and the light guide into the display device.
